(19) United States
(12) Patent Application Publication
(10) Pub. No.: US 2007/0221879 A1
(43) Pub. Date: Sep. 27, 2007

(54) Safe storage, transportation and delivery of chlorine

(75) Inventors: Ryan J. Hulse, Getzville, NY (US); Rajiv R. Singh, Getzville, NY (US); Martin R. Paonessa, Niagara Falls, NY (US)

Correspondence Address: Honeywell International Inc.;Patent Services Group AB2, P.O. Box 2245, Morristown, NJ, 07962, US

(73) Assignee: HONEYWELL INTENATIONAL INC.

(21) Appl. No.: 11/385,453

(22) Filed: Mar. 21, 2006

(51) Int. Cl. A01N 59/08; C09K 3/00; C01B 31/16

(52) U.S. Cl. 252/184; 424/661

(57) ABSTRACT

An improved system and method for the storage, transportation or delivery of chlorine is provided by mixing or dissolving the chlorine in organic salts that are non-reactive with chlorine and that lowers the vapor pressure of the chlorine to ambient pressure of about 14.7 psia or lower, and wherein the chlorine can be released or delivered by subjecting the mixture to heating or a vacuum.

### FIELD OF THE INVENTION

This invention relates to a system and method for the safe storage, transportation and delivery of chlorine under low pressure conditions. According to the invention there is provided a system for lowering the vapor pressure of chlorine to or below ambient pressure so that the reduced vapor pressure would insure that even if there were a leak or spill in the storage system or in the transportation of the chlorine there would be only a very minimal or essentially no amount of chlorine released into the atmosphere.

### BACKGROUND TO THE INVENTION

Of all the halogens, chlorine is by far the most abundant in nature and is easiest to produce. More than 855 of all pharmaceuticals and more than half of the products of the chemical industry depend upon chlorine chemistry. Approximately 75 billions pounds per year were used in the United States alone in year 2004. These products are used in most industrial and economic sectors including healthcare, agro-food, building, textile, transport, leisure activity and cosmetics industries.

Generally, the chlorine, a gas with a boiling point of −34° C. is stored and shipped as compressed liquefied gas. However, the vapor pressure at 25° C. is 113 psia. Thus, chlorine gas can present a significant safety risk and environmental challenge due to its high toxicity, volatility, reactivity and corrosive properties. Due to these safety concerns there are numerous requirements and standards written to control the safe storage and transportation of chlorine. To confront this problem and safety concerns mechanical solutions to the problems, such as the use of valving systems and use of double walled containers and the like, have been proposed. However, none of these proposed solutions have really been sufficiently adequate to sufficiently minimize the risks. There is, therefore, a need for improved technology and a system for storing, transporting and delivering chlorine that further minimizes these risks.

### SUMMARY OF THE INVENTION

In accordance with this invention there is provided an improved system and method for the storage, transportation or delivery of chlorine by mixing or dissolving the chlorine in organic salts that are non-reactive with chlorine and that lowers the vapor pressure of the chlorine to ambient pressure of about 14.7 psia or lower. In an embodiment of the invention there is provided a system and method for storage, transportation or delivery of chlorine comprising a vessel adapted to store, transport or deliver chlorine and containing chlorine dissolved in an organic salt that is non-reactive with chlorine and lowers the vapor pressure of the chlorine to ambient pressure or lower. In one embodiment of the invention the organic salt comprises an ionic liquid, namely an organic salt having a melting point of below 100° C. In a further embodiment of the invention the organic salt is an imidazolium or pyridinium based organic salt, preferably a substituted imidazolium chloride. With the system and method of this invention, the reduction in the vapor pressure of the chlorine insures that even if a leak or spill from the vessel occurs during storage transportation or delivery of the chlorine there would be only a very minimal, if any at all, amount of chlorine released to the environment. Additionally, the system and method is able to avoid the requirement that the chlorine be stored in high pressure vessels. The chlorine can be dissolved in one or more of the organic salt compounds, i.e., a mixture of organic salts may be employed. For delivery of the chlorine the method of the invention comprises
(a) providing a vessel adapted to store, transport or deliver chlorine and containing chlorine dissolved in an organic salt that is non-reactive with chlorine and lowers the vapor pressure of the chlorine to ambient pressure or lower, and
(b) releasing the chlorine by passing a vacuum over the mixture or heating the mixture.

### BRIEF DESCRIPTION OF THE DRAWINGS

FIG. 1 is a graph of the pressure in psia of various concentrations of chlorine in a mixture of chlorine in 1-methyl-3-ethylimidazolium chloride;

FIG. 2 is a first DSC scan of a mixture of 52 wt % chlorine in 48 wt % 1-methyl-2-ethylimidazolium chloride at temperatures of from 20° C. to 180° C.;

FIG. 3 is a second (subsequent) DSC scan of the mixture of 52 wt % chlorine in 48 wt % 1-methyl-2-ethylimidazolium chloride of FIG. 2 at temperatures of from 20° C. to 180° C.; and

FIG. 4 is a graph of the pressure in psia of various concentrations of chlorine in a mixture of chlorine in pyridinium hydrochloride.

### DETAILED DESCRIPTION OF THE INVENTION

This invention provides an improved system and method for the storage, transportation or delivery of chlorine by mixing or dissolving the chlorine in one or more organic salts that are non-reactive with chlorine and that lowers the vapor pressure of the chlorine to ambient pressure of about 14.7 psia or lower. In an embodiment of the invention there is provided a system and method for storage, transportation or delivery of chlorine comprising a vessel adapted to store, transport or deliver chlorine and containing chlorine dissolved in an organic salt that is non-reactive with chlorine and lowers the vapor pressure of the chlorine to ambient pressure or lower. In one embodiment of the invention the organic salt comprises an ionic liquid, namely an organic salt having a melting point of below 100° C. In a further embodiment of the invention the organic salt is an imidazolium, quaternary ammonium or pyridinium based organic salt, preferably a substituted imidazolium chloride. For delivery of the chlorine the method of the invention comprises
(c) providing a vessel adapted to store, transport or deliver chlorine and containing chlorine dissolved in an organic salt that is non-reactive with chlorine and lowers the vapor pressure of the chlorine to ambient pressure or lower, and
(d) releasing the chlorine by passing a vacuum over the mixture or heating the mixture.
   With the system and method of this invention, the reduction in the vapor pressure of the chlorine insures that even if a leak or spill from the vessel occurs during storage transportation or delivery of the chlorine there would be only a very minimal, if any at all, amount of chlorine released to the environment.

With the system and method of this invention additional advantages are obtained due to the fact that the organic salts employed as the storage, transportation or delivery medium are non-flammable, chemically inert and typically have very negligible vapor pressures. Thus, the mixture of the chlorine with the organic salt is ideal for the storage, transportation and delivery of the toxic, highly volatile reactive and corrosive chlorine without presenting undue environmental or safely risks. Furthermore, chlorine is readily and easily extracted from the mixture of chlorine in the organic salt by heating the mixture or passing a vacuum over the mixture since the organic salt will not enter the vapor phase, due to its negligible vapor pressure, yet the chlorine will be readily released or extracted from the mixture.

In accordance with this invention the chlorine is mixed with an organic salt that is non-reactive with chlorine and lowers the vapor pressure of the chlorine to ambient pressure or lower. The organic salts used in accordance with this invention are those organic salts that are chemically inert to chlorine and that when combined with the chlorine effectively decrease the vapor pressure to essentially ambient conditions of about 14.7 psia or lower. The amount of chlorine that can be stored in the organic salt is determined by adding a sufficient amount of chlorine to the organic salt so that the overall pressure is equal to about 14.7 psia or lower. At this particular weight percent only a minimal amount of chlorine will be released to the environment in the case of an accidental leak or spill.

Any suitable organic salt that is essentially chemically inert to chlorine and that lowers the vapor pressure to about ambient pressure or below may be employed in this invention. In one aspect of the invention the organic salt is an ionic liquid that has a melting point of less than 100° C. In another aspect of this invention the organic salt is an organic salt that is selected from salts of tetraalkylphosphonium, tetraalkylammonium, pyridinium, N-alkylpyridinium, or N,N′-dialkylimidazolium cations. Common cations generally can contain C₁₋₁₈ alkyl groups, and include the ethyl, butyl and hexyl derivatives of N-alkyl-N′-methylimidazolium and N-alkylpyridinium. Other cations include pyridazinium, pyrimidinium, pyrazinium, pyrazolium, triazolium, thiazolium, and oxazolium. Preferably, the organic salts of this invention are imidazolium and pyridinium salts, and most preferably a substituted imidazolium chloride. A wide variety of anions can be matched with the cation component. One type of anion is derived from a metal halide. The halide most often used is chloride although the other halides may also be used. Preferred metals for supplying the anion component, e.g., the metal halide, include copper, aluminum, iron, cobalt, chromium, zinc, tin, antimony, titanium, niobium, tantalum, gallium, and indium. Examples of metal chloride anions are CuCl₂⁻, Cu₂Cl₃⁻, AlCl₄⁻, Al₂Cl₇⁻, CoCl₃⁻, CrCl₄⁻, ZnCl₃⁻, ZnCl₄²⁻, Zn₂Cl₅⁻, FeCl₃⁻, FeCl₄⁻, Fe₂Cl₇⁻, TiCl₅⁻, TiCl₆²⁻, SnCl₅⁻, SnCl₆²⁻, and the like. Other commonly used anions include carboxylates, fluorinated carboxylates, sulfonates, fluorinated sulfonates, imides, borates, phosphates, chloride, and the like Among these there may be mentioned for example BF₄⁻, PF_{6.} -, p-CH₃—C₆H₄SO₃⁻, CF₃SO₃⁻, CH₃OSO₃⁻, CH₃CH₂OSO₃⁻, (CF₃SO₂)₂N⁻, (NC)₂N⁻(CF₃SO₂)₃C⁻, CH₃COO— and CF₃COO⁻.

Examples of halide liquid organic salt compounds include: 1-ethyl-3-methylimidazolium bromide; 1-ethyl-3-methylimidazolium chloride; 1-butyl-3-methylimidazolium bromide; 1-butyl-3-methylimidazolium chloride; 1-hexyl-3-methylimidazolium bromide; 1-hexyl-3-methylimidazolium chloride; 1-methyl-3-octylimidazolium bromide; 1-methyl-3-octylimidazolium chloride; monomethylamine hydrochloride; trimethylamine hydrochloride; tetraethylammonium chloride; tetramethyl guanidine hydrochloride; N-methylpyridinium chloride; N-butyl-4-methylpyridinium bromide; N-butyl-4-methylpyridinium chloride; tetrabutylphosphonium chloride; and tetrabutylphosphonium bromide

As further examples of suitable organic salts and particularly ionic liquids suitable for use in this invention there may me mentioned the following organic salt compounds available from Aldrich Chemical Company.

Halogen-free ionic liquids

| Aldrich | | |
|---|---|---|
| Catalog | | |
| No. | Product Name | CAS No. |
| 89155 | 1-Ethyl-3-methylimidazolium | 328090-25-1 |
| | tosylate (EMIM-Ts) | |
| 75059 | 1-Butyl-3-methylimidazolium | — |
| | octyl sulfate (BMIM-OctSO₄) | |
| 67421 | 1-Butyl-3-methylimidazolium 2-(2- | — |
| | methoxyethoxy)ethyl sulfate (BMIM-MDEESO₄) | |

Imidazolium derivatives

| Aldrich Catalog No. | Product Name | CAS No. |
|---|---|---|
| 39056 | 1-Ethyl-3-methylimidazolium bis(pentafluoroethylsulfonyl)imide (EMIMBeTi) | 216299-76-2 |
| 11291 | 1-Ethyl-3-methylimidazolium bis(trifluoromethylsulfonyl)imide (EMIMBMeI) | 174899-82-2 |
| 89483 | 1-Ethyl-3-methylimidazolium bromide | 65039-08-9 |
| 72924 | 1-Ethyl-3-methylimidazolium chloride | 65039-09-0 |
| 46093 | 1-Ethyl-3-methylimidazolium hexafluorophosphate | 155371-19-0 |
| 04363 | 1-Ethyl-3-methylimidazolium nitrate | 143314-14-1 |
| 04365 | 1-Ethyl-3-methylimidazolium tetrafluoroborate | 143314-16-3 |
| 04367 | 1-Ethyl-3-methylimidazolium trifluoromethanesulfonate | 145022-44-2 |
| 95137 | 1-Butyl-3-methylimidazolium bromide | 85100-77-2 |
| 94128 | 1-Butyl-3-methylimidazolium chlorid | 79917-90-1 |
| 83086 | 1-Butyl-3-methylimidazolium methyl sulfate | — |
| 76420 | 1-Butyl-3-methylimidazolium trifluoromethane sulfonate | 174899-66-2 |
| 70956 | 1-Butyl-3-methylimidazolium hexafluorophosphate | 174501-64-5 |
| 91508 | 1-Butyl-3-methylimidazolium tetrafluoroborate | 174501-65-6 |
| 87929 | 1-Hexyl-3-methylimidazolium chloride | 171058-17-6 |
| 89320 | 1-Hexyl-3-methylimidazolium hexafluorophosphate | 304680-35-1 |
| 73244 | 1-Hexyl-3-methylimidazolium tetrafluoroborate | 244193-50-8 |
| 95803 | 1-Methyl-3-octylimidazolium chloride | 64697-40-1 |
| 96324 | 1-Methyl-3-octylimidazolium tetrafluoroborate | 244193-52-0 |
| 44979 | 1-Methyl-3-(3,3,4,4,5,5,6,6,7,7,8,8,8-tridecafluoroctyl)-imidazolium- | 313475-50-2 |
| | hexafluorophosphat | |
| 93607 | 1,3-Dimethylimidazolium methyl sulfate | 97345-90-9 |
| 74305 | 1,2-Dimethyl-3-propylimidazolium tris(trifluoromethylsulfonyl)methide (DMPIMe) | 169051-77-8 |

Pyridinium derivatives

| Aldrich | | |
|---|---|---|
| Calalog | | |
| No. | Product Name | CAS No. |
| 30565 | 3-Methyl-1-propylpyridinium | — |
| | bis(trifluormethylsulfonyl)imide (PMPIm) | |
| 14654 | 1-Butyl-3-methylpyridinium | 344790-86-9 |
| | bis(trifluormethylsulfonyl)imide (BMPIm) | |
| 88482 | 1-Butyl-4-methylpyridinium chloride | 112400-86-9 |
| 88458 | 1-Butyl-4-methylpyridinium hexafluorophosphate | — |
| 73261 | 1-Butyl-4-methylpyridinium tetrafluoroborate | 343952-33-0 |

The amount of chlorine that can be stored in the organic salt is determined by adding a sufficient amount of chlorine to the organic salt so that the overall pressure is equal to about 14.7 psia or lower. At this particular weight percent only a minimal amount of chlorine will be released in the case of an accidental leak or spill.

While special vessels may be employed to initially mix the chlorine with the one or more organic salt compounds, after the mixture of chlorine absorbed or dissolved in the organic salt compounds is obtained, the mixture may even be a kept in a suitable open vessel. During the shipment or storage of the chlorine in the organic salt the pressure will remain at or below 14.7 psia. In order to separate the pure chlorine out of the organic salt ether heat or a vacuum could be applied to the mixture. Since the organic salt has negligible vapor pressure it will not enter the vapor phase as the mixture is heated or a vacuum is applied. After the chlorine has been removed the organic salt can then be reused to store or transport additional chlorine.

If the chlorine is going to be removed via temperature, the storage or transportation vessel would be sufficiently heated to cause the evolution of chlorine bubbles. The temperature at which the chlorine bubbles would begin to appear is specific to the organic salt that is used. The temperature can be readily determined, such as by subjecting the mixture of chlorine and organic salt Differential Scanning Calorimetry (DSC). If no heat source is available the chlorine could be removed by applying a vacuum to the system. The pressure at which the chlorine is removed can be readily determined, such as by subjecting the mixture of chlorine and organic salt to a vapor pressure measurement.

The invention is illustrated, but not limited to, the following illustrative examples.

### EXAMPLE 1

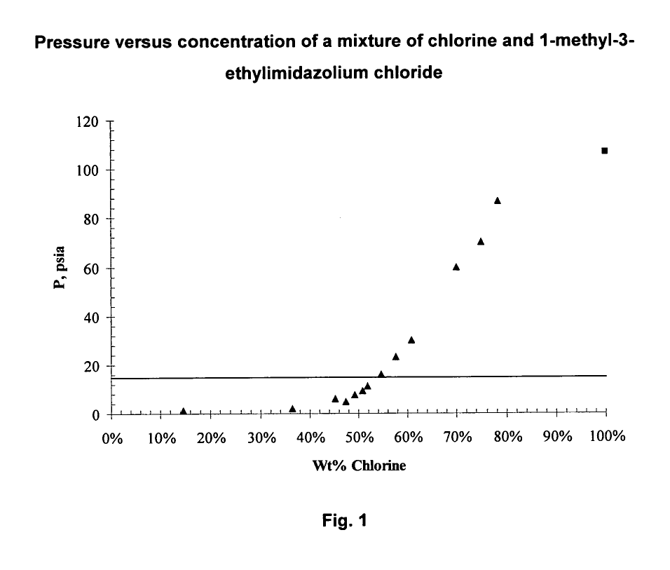

In this example chlorine was added to 1-methyl-3-ethylimidazolium chloride. The initial amount of 1-methyl-3-ethylimidazolium chloride was recorded. Then small amounts of chlorine were incrementally added and the overall pressure of the system was monitored. The pressure versus chlorine weight percent relationship is shown in FIG. 1 wherein the ▴ are the experimental points and the ▪ represents the vapor pressure of pure chlorine. 1-methyl-3-ethylimidazolium chloride is able to store up to 54 wt % chlorine, based on the total combined weight of the chlorine and organic salt, while maintaining a pressure of less than 14.7 psia

### EXAMPLE 2

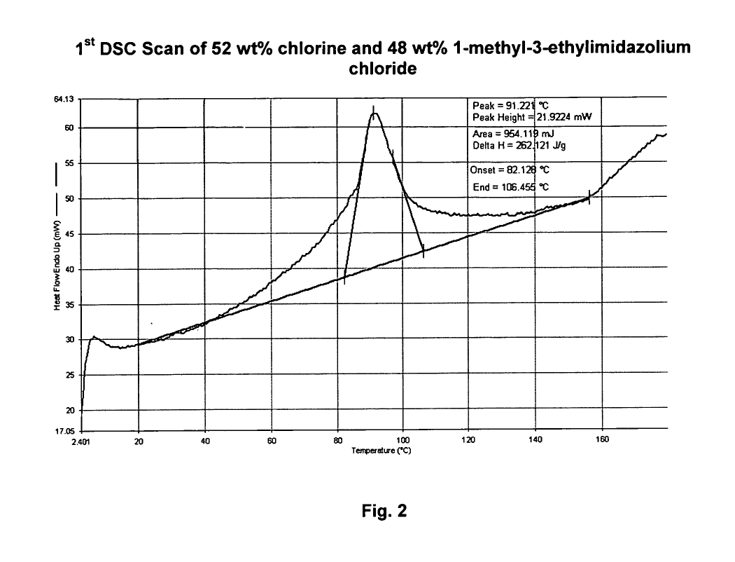

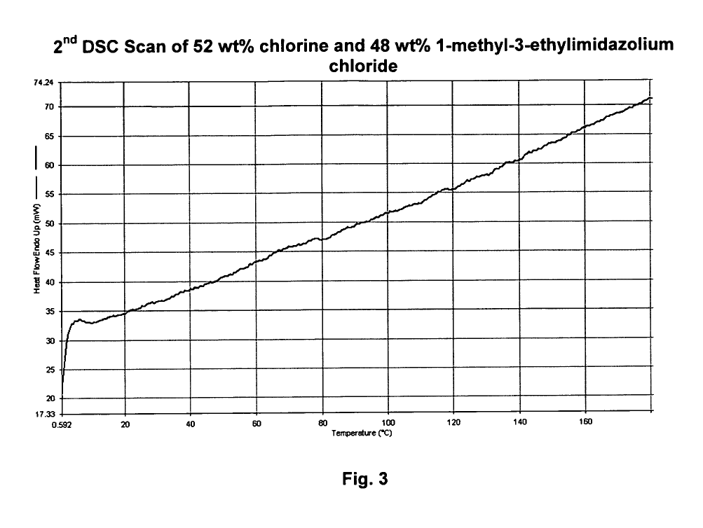

A mixture if 52 wt % chlorine and 48 wt % 1-methyl-3-ethylimidazolium chloride was analyzed by Differential Scanning Calorimetry (DSC) to look at any potential reactions at elevated temperature. The DSC scan was run at temperatures ranging from 20 to 180° C. A single peak (FIG. 2) was observed that was centered at 91° C. A second DSC scan was run of the same sample over the same temperature range. The second DSC scan (FIG. 3) contained no peaks. This indicates that the peak seen in the first scan was from the release on the chlorine. The second scan indicated that all the chlorine had been released in the first scan. This shows that not only is the sample stable but the chlorine will start to be released at about 50° C.

### EXAMPLE 3

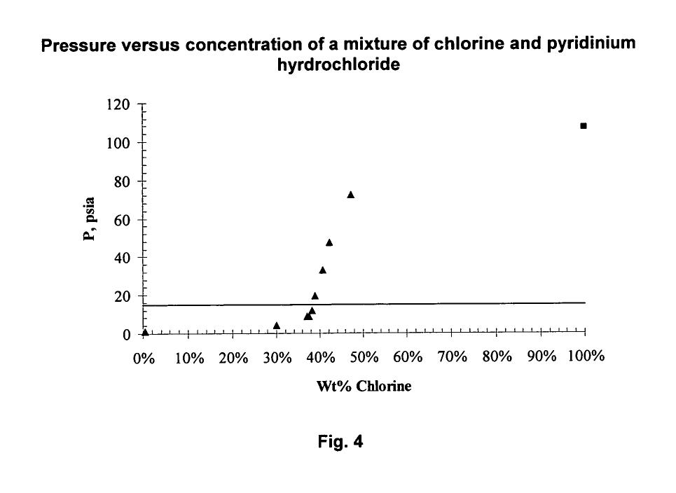

In this example chlorine was added to pyridinium hyrdrochloride. The initial amount of pyridinium hyrdrochloride was recorded. Then small amounts of FIG. 4 wherein the ▴ are the experimental points and the ▪ represents the vapor pressure of pure chlorine. Pyridinium hyrdrochloride is able to store up to 39 wt % chlorine, based on the total combined weight of the chlorine and organic salt, while maintaining a pressure of less than 14.7 psia.

Having described the invention in detail by reference to the preferred embodiments and specific examples thereof, it will be apparent that modifications and variations are possible without departing from the spirit and scope of the disclosure and claims.

We claim:

1. A system for the storage, transportation or delivery of chlorine comprising a vessel adapted to store, transport or deliver chlorine and containing chlorine dissolved in an organic salt that is non-reactive with chlorine and lowers the vapor pressure of the chlorine to ambient pressure or lower.

2. A system according to claim 1 wherein the organic salt is an ionic liquid.

3. A system according to claim 1 wherein the organic salt is a compound selected from the group consisting of salts of tetraalkylphosphonium, tetraalkylammonium, pyridinium, N-alkylpyridinium, and N,N′-dialkylimidazolium cations.

4. A system according to claim 1 wherein the organic salt is selected from the group consisting of imidazolium and pyridinium salts.

5. A system according to claim 1 wherein the organic salt comprises of a substituted imidazolium chloride.

6. A system according to claim 1 the organic salt comprises 1-methyl-3-ethylimidazolium chloride.

7. A system according to claim 1 comprising about 54 wt % chlorine and 46 wt % 1-methyl-3-ethylimidazolium chloride.

8. A system according to claim 1 comprising about 39 wt % chlorine and 61 wt % pyridinium hydrochloride.

9. A method of delivering chlorine comprising:
(e) providing a vessel adapted to store, transport or deliver chlorine and containing chlorine dissolved in an organic salt that is non-reactive with chlorine and lowers the vapor pressure of the chlorine to ambient pressure or lower, and
(f) releasing the chlorine by heating the mixture.

10. A method of delivering chlorine comprising:
(a) providing a vessel adapted to store, transport or deliver chlorine and containing chlorine dissolved in an organic salt that is non-reactive with chlorine and lowers the vapor pressure of the chlorine to ambient pressure or lower, and
(b) releasing the chlorine by passing a vacuum over the mixture.
